(19) United States
(12) Patent Application Publication
(10) Pub. No.: US 2006/0080496 A1
(43) Pub. Date: Apr. 13, 2006

(54) Recorder data recording method recorder, data recording program, recorded medium on which the program is recorded

(76) Inventors: Tomoyuki Miyake, Nara-shi (JP); Narutoshi Inoue, Higashihiroshima-shi (JP)

Correspondence Address: EDWARDS & ANGELL, LLP, P.O. BOX 55874, BOSTON, MA, 02205, US

(21) Appl. No.: 10/539,933

(22) PCT Filed: Dec. 3, 2003
(86) PCT No.: PCT/JP03/15495

§ 371 Date: Jun. 16, 2005

(30) Foreign Application Priority Data
Dec. 18, 2002 (JP) 2002-367305

(51) Int. Cl. G06F 12/14

(52) U.S. Cl. 711/100

(57) ABSTRACT

In a method for recording a plurality of data, at least a part of which are simultaneously received, onto a recording medium with the use of a recording apparatus for recording the data, continuous vacant regions in the recording medium is detected; and each of vacant regions having a recording capacity larger than data amount of each of the data is selected, from the detected vacant regions, for each of the data; and corresponding data is recorded onto the selected vacant regions, respectively. This method allows prevention of failure of recording the simultaneously received data onto the recording medium.

### TECHNICAL FIELD

The present invention relates to a data recording method using a recording apparatus, a recording apparatus, a data recording program, and a recording medium storing the program, whereby at least a part of a plurality of simultaneously received data, particularly contents data such as an image and sound are recorded onto a recording medium. Specifically, the present invention relates to (i) a disc recording apparatus capable of simultaneous recording of television broadcasting programs, and (ii) a broadcasting program recording method in the recording apparatus.

### BACKGROUND ART

What has been available in recent years are: a terrestrial broadcasting service, a BS (broadcasting satellite) broadcasting service, a CS (communication satellite) broadcasting service, a digital BS (broadcasting satellite) broadcasting service, and a digital CS (communication satellite) broadcasting service. Further, a digital terrestrial broadcasting service will be started in Japan in 2003. Provided in response to such a circumstance are: a recording apparatus and a television receiver, each of which includes a tuner accommodating to a plurality of broadcasting media.

This causes an increase in the number of viewable broadcasting programs, so that a demand arises in (i) simultaneous reproduction of a plurality of broadcasting programs, (ii) simultaneous recording of a plurality of broadcasting programs, or (iii) reproduction of one broadcasting program while recording another broadcasting program. Such simultaneous recording of a plurality of broadcasting programs has already realized in a VTR (Video Tape Recorder), as disclosed by Japanese Laid-Open Patent Publication Tokukaihei 09-307846 (published on Nov. 28, 1997).

Meanwhile, a recent high-speed large-volume random accessible disk (disc) recording apparatus (drive), such as a hard disk drive (HDD) and an optical disc drive, allows implementation of a disk recording apparatus that is capable of long-time image recording. A method for recording a plurality of broadcasting programs onto such a disk recording apparatus is disclosed by Japanese Laid-Open Patent Publication Tokukai 2001-186472 (published on Jul. 6, 2001).

Incidentally, in a digital broadcasting such as the digital CS broadcasting, a plurality of broadcasting programs are so multiplexed as to be transmitted as one digital stream. Japanese Laid-Open Patent Publication Tokukaihei 10-243348 (published on Sep. 11, 1998) discloses a method for simultaneously recording such broadcasting programs after extracting the broadcasting programs from the digital stream.

Further, Japanese Laid-Open Patent Publication Tokukai 2000-217063 (published on Aug. 4, 2000) discloses a method for simultaneously recording or simultaneously reproducing, in reference to an electronic programming guide (EPG) for use in the digital broadcasting, a plurality of broadcasting programs broadcasted at the same time.

Further, improvements in a high-speed recording property and a buffering technique have already allowed a recent optical disc recording apparatus to have the function of recording a broadcasting program while reproducing another broadcasting program. A specific example of such an optical disc recording apparatus is a commercially available DMR-HS2 optical disc apparatus provided by Matsushita Electric Industrial Co., Ltd.

However, in cases where such a random accessible disc recording apparatus carries out random recording with respect to a recording medium, traveling speed (seeking time) of a pickup is a bottleneck in realization of the above simultaneous recording. A reason for this is as follows. That is, in the random recording, data in a single file are likely to be randomly and separately stored in the recording disc. Therefore, the simultaneous recording possibly fails according to the traveling speed of the pickup, traveling distance thereof, or frequency (the number) of traveling, even when recording rate is sufficiently high and when a buffer memory is used for temporary data storage.

The present invention is made to solve the problem, and its object is to provide a data recording method using a recording apparatus; a recording apparatus; a data recording program; and a recording medium storing the program, whereby the recording failure is prevented by reducing the seeking operation of the pickup while recording, onto the recording medium, at least a part of a plurality of simultaneously received data.

### DISCLOSURE OF INVENTION

To solve the problem, a method, of the present invention, for recording a plurality of data, at least a part of which are simultaneously received, onto a recording medium with the use of a recording apparatus for recording the data, the method comprising the steps of: (a) detecting continuous vacant regions in the recording medium; (b) selecting, from the detected vacant regions, for each of the data, at least one vacant region having a recording capacity larger than data size of said each of the data; and (c) recording corresponding data onto the selected vacant regions, respectively.

Generally, speed of recording data onto a recording medium is faster than speed of distributing data from information media such as a newspaper publisher and a broadcasting station. Therefore, the method makes it possible that each of the simultaneously received (inputted) data is recorded onto the continuous region in the recording medium.

With this, the pickup carries out the seeking operation only when recording a part of data onto a continuous recording region after recording a part of another data onto another continuous recording region. That is, no seeking operation is carried out within each recording region onto which each data is to be recorded. This makes it possible that the seeking operation is less frequently carried out, thereby preventing recording failure of the simultaneously received data.

Note that, in cases where the recording medium has a plurality of recording layers, and where the continuous vacant region continues over recording layers, the pickup possibly carries out the seeking operation so as to move from (i) a terminal of a recording layer to which recording was carried out, to (ii) a start of a next recording layer to which recording is to be carried out. However, even in the case, frequency of the seeking operation can be restrained to several times or so. This allows prevention of the recording failure of the simultaneously received data.

Further, the present invention assumes that the simultaneously received data encompasses time-division multiplexed data. Further, the present invention is effective when the data is data having an extremely long data length. A specific example of such data is contents data such as image and sound.

Further, to solve the problem, a recording apparatus, of the present invention, for recording a plurality of data, at least a part of which are simultaneously received, onto a recording medium, the recording apparatus includes: detecting means for detecting continuous vacant regions in the recording medium; selecting means for selecting, from the detected vacant regions, for each of the data, at least one vacant region having a recording capacity larger than data size of each of the data; and recording control means for recording corresponding data onto the selected vacant regions, respectively.

With the structure, the data are recorded onto the vacant regions in the recording medium, respectively. With this, the pickup carries out the seeking operation only when parts of different data are respectively recorded onto vacant regions. That is, no seeking operation is carried out within one recording region onto which one data is to be recorded. This allows the seeking operation to be carried out less frequently, and therefore prevents recording failure of the recording due to repetition of the seeking operation.

Note that it is possible to cause a computer to perform, by way of a data recording program, the steps carried out according to the data recording method using the recording apparatus. Further, the data recording program can be executed by an arbitrary computer, by way of a recording medium storing the data recording program.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram schematically illustrating an optical disc recording/reproducing apparatus that is one embodiment of the present invention.

FIG. 2 is a diagram illustrating a picture recording schedule in the optical disc recording/reproducing apparatus.

FIG. 3 is a flowchart illustrating a picture recording control process in the optical disc recording/reproducing apparatus.

FIG. 4 is a flowchart illustrating details of a disc information acquirement process shown in FIG. 3.

FIG. 5 is a flowchart illustrating details of a picture recording scheduling process shown in FIG. 3.

FIG. 6 is a flowchart illustrating details of a picture recording performing process shown in FIG. 3.

FIG. 7 is a schematic diagram illustrating an optical disc onto which data corresponding to two broadcasting programs were recorded by the optical disc recording/reproducing apparatus.

### BEST MODE FOR CARRYING OUT THE INVENTION

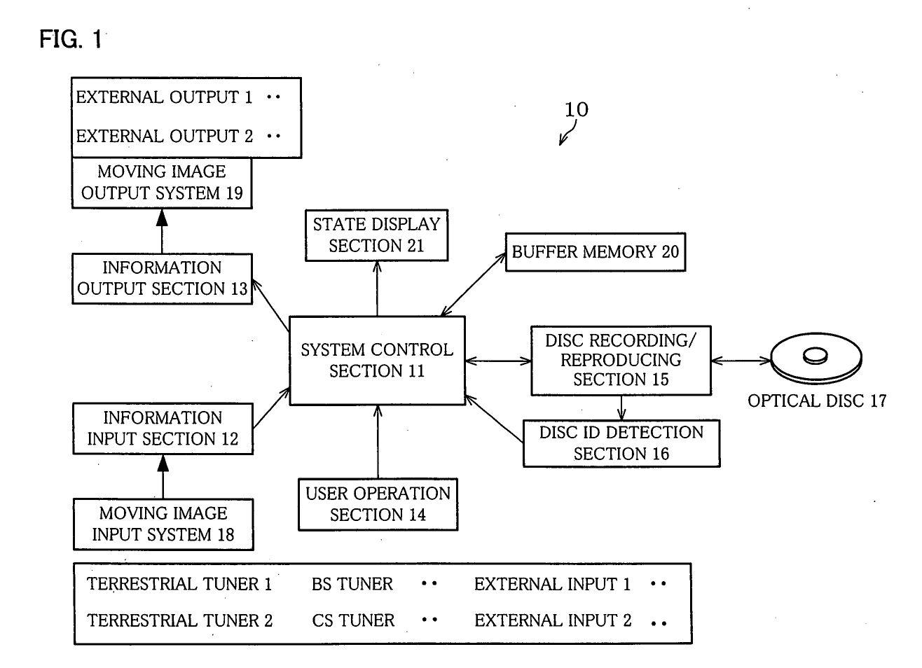

One embodiment of the present invention will be explained below with reference to FIG. 1 through FIG. 7. FIG. 1 schematically illustrates a structure of an optical disc recording/reproducing apparatus allowing realization of the broadcasting program recording method of the present invention. The optical disc recording/reproducing apparatus 10 carries out data recording and data reproduction with respect to an optical disc 17.

The optical disc recording/reproducing apparatus 10 includes a system control section 11, an information input section 12, an information output section 13, a user operation section 14, a disc recording/reproducing section 15, a disc ID detection section 16, a moving image input system 18, a moving image output system 19, a buffer memory 20, and a state display section 21.

The disc recording/reproducing section 15 receives, from the system control section 11, contents data including image information and audio information, and converts the received data into such data that the optical disc 17 can store, and records the converted data onto optical disc 17. Moreover, the disc recording/reproducing section 15 reads out contents data stored in the optical disc 17, and converts the readout contents data into such data that the information output section 13 can reproduce, and transmits the converted data to the system control section 11.

Further, the disc recording/reproducing section 15 carries out a format process with respect to the optical disc 17, in response to an instruction from the system control section 11. Upon completion of the format process with respect to the optical disc, the disc recording/reproducing section 15 notifies, to the system control section 11, the completion of the format process.

The optical disc 17 stores contents data. Some optical disc 17 includes a unique disc ID, which is an identification code of the optical disc 17.

The disc ID detection section 16 detects such a disc ID in response to insertion of the optical disc 17 having the disc ID. In the present embodiment, the disc ID detection section 16 is provided in the optical disc recording/reproducing apparatus 10, and utilizes a bar code reader so as to acquire the disc ID by optically reading a bar code printed on a paper label adhered to the optical disc 17. Namely, the paper label is adhered to a predetermined portion of the optical disc 17 by a user such that the disc ID of optical disc 17 is detected.

When detecting the disc ID, the disc ID detection section 16 transmits information of the disc ID to the system control section 11. Note that, in the disc ID detection section 16, the aforementioned example is not only means for detecting the optical disc 17. For example, a disc ID may be detected from a non-contact accessible IC chip that is provided on an optical disc 17 or a cartridge (not shown) that stores the disc ID. Alternatively, an identification code may be used which is written in a recording surface of the optical disc 17. A specific example of the recording surface is a BCA (Burst Cutting Area) region in a DVD (Digital Versatile Disk).

The information input section 12 receives contents data of a television broadcasting via the moving image input system 18, and transmits the received contents data to the system control section 11. Moreover, the information input section 12 selects any of a plurality of tuners and external inputs, each of which is provided in the moving image input system 18. The information input selection 12 receives contents data from the selected tuner or the external input.

Note that the information input section 12 may have a decode function for decoding compressed moving image data and/or compressed audio data. Note also that the information input section 12 may have a function for importing broadcasting program information such as the EPG.

The information output section 13 receives contents data from the system control section 11, and reproduces or outputs the received contents data. Specifically, the information output section 13 displays image information of the contents data on an image display apparatus such as a CRT (cathode ray tube), and sends audio information of the contents data to an audio output apparatus such as a speaker.

The information output section 13 can receive a contents selection menu from the system control section 11, and can reproduce or output the received contents selection menu. Here, the wording “contents selection menu” refers to (i) a displayed list of titles of the contents, (ii) a displayed catalogue of thumbnail images showing what the contents item is about. The user selects a desired contents item of the contents selection menu via the user operation section 14. With this, the number of the selected contents information is notified to the system control section 11.

The buffer memory 20 is a memory apparatus for temporarily storing readout moving image information from the disc. Normally, the buffer memory 20 stores the contents data. Generally, the buffer memory 20 is also used for temporary storage of data to be recorded onto the optical disc 17. The present embodiment uses the buffer memory 20 upon recording of different broadcasting programs onto different radial-direction positions of the disc. For example, upon recording of two contents data (broadcasting programs), the buffer memory 20 is partitioned (divided) in two such that the buffer memories thus obtained by the partitioning are respectively used as data buffers for the two contents data.

The state display section 21 displays apparatus state information indicating a state of the apparatus. Examples of the apparatus state information include recording state and reproduction state. Moreover, the state display section 21 is able to display a picture recording schedule, information obtained from the EPG, and the like.

The system control section 11 has overall control over the components of the disc recording apparatus 10. Specifically, the system control section 11 controls, in accordance with an input user's operation via the user operation section 14, (i) respective operations of the components, and (ii) data transfer therebetween. Note that the control operation by the system control section 11 will be explained later.

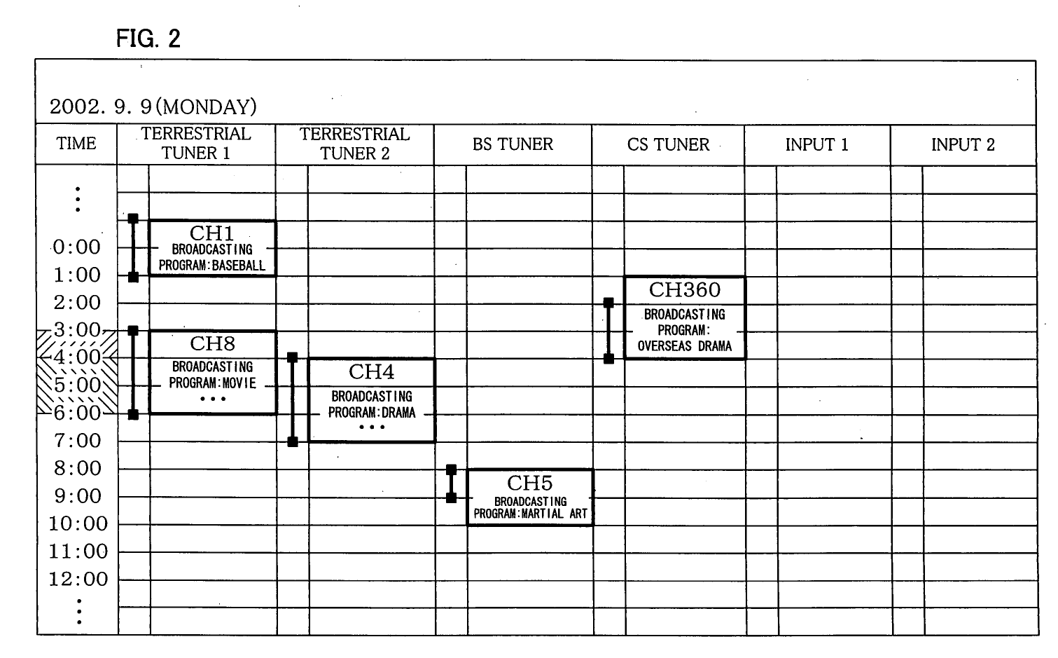

The following specifically explains the operations in the optical disc recording/reproducing apparatus 10 having the above structure. FIG. 2 exemplifies a scheduled picture recording in each input on Sep. 9 (Monday), 2002. In FIG. 2, each region surrounded by a bold line corresponds to a period of time of a broadcasting program to be recorded. Described on a left-hand side with respect to the region is time of a to-be-actually-recorded part of the broadcasting program. As such, only the designated part of the broadcasting program can be recorded by designating an arbitrary period of time of the broadcasting program to be recorded.

In FIG. 2, from 3 o'clock to 4 o'clock, a broadcasting program from a terrestrial tuner 1 and a broadcasting program from a CS tuner will be simultaneously recorded. Further, from 4 o'clock to 6 o'clock, the broadcasting program from the terrestrial tuner 1 and a broadcasting program from a terrestrial tuner 2 will be simultaneously recorded.

Note that data transmitting speed of broadcasting program data from broadcasting media is substantially determined according to image quality of the broadcasting program data. Examples of the broadcasting media include the terrestrial broadcasting media, the CS digital broadcasting media, and the BS digital broadcasting media. For example, transmitting speed of broadcasting program data having normal image quality is approximately 4 Mbps (Megabit per second) or so, whereas transmitting speed of broadcasting program data having high vision image quality is approximately 23 Mbps (Megabit per second) or so. Further, in cases where moving image data having DVD level image quality is transmitted from the moving image input system 18, data transfer rate of the moving image data is on the order of 5 Mbps in average, and is 10 Mbps at the maximum.

On the other hand, as apparent from, e.g., a 2×-12× CD drive or a 2×-12× DVD drive, data transfer rate (reading speed of a recording medium, and writing speed thereof) when the disc recording/reproducing section 15 carries out recording or reproduction with respect to the optical disc 17 can be as fast as possible irrespective of a broadcasting standard, a moving image standard, and the like. A HDD and an optical disc drive at the present time are able to carry out recording and reproduction at a speed of 25 Mbps to 100 Mbps. This makes it possible for the disc recording/reproducing section 15 to carry out recording of plural sets of simultaneously received data.

In the present embodiment, from 3 o'clock to 6 o'clock, two broadcasting programs are recorded at a time. To accommodate this, the system control section 11 divides a memory region of the buffer memory 20 into two such that: data of one broadcasting program from one tuner is accumulated in one of the divided memory regions, and data of the other broadcasting program from the other tuner is accumulated in the other divided memory region. On this occasion, recording of the data onto the optical disc 17 is required to be carried out before each memory region in the buffer memory 20 is filled with the data.

See an example in which the buffer memory 20 has a memory volume of 200 Mbits (25 Mbytes), and in which the data is accumulated in the buffer memory 20 at a rate of 5 Mbps that is an average reproduction rate of a DVD. In this case, each of the memory regions corresponding to the respective broadcasting programs has a memory volume of 100 Mbits. Therefore, it takes 20 seconds until the data fills each of the memory regions respectively corresponding to the broadcasting programs.

On the other hand, the contents data is recorded onto the optical disc 17 at a data transfer rate of 30 Mbps, so that it takes approximately 3.3 seconds to record the 100 Mbits data onto the optical disc 17. Precisely speaking, the data from the tuner keeps being accumulated during the recording onto the optical disc 17, so that it takes 3.3 seconds plus approximately 0.5 seconds to record, onto the optical disc 17, substantially all the data in the memory region corresponding to the broadcasting program.

Specifically, the use of the buffer memory 20 allows the following effect. That is, because the recording of the data in the memory region is finished in 4 seconds or less of 20 seconds of the practicable data accumulating time, no data in the memory region is required to be recorded onto the optical disc 17 for at least 16 seconds. Therefore, the data accumulated in the other memory region can be recorded in 16 seconds. For the recording, the pickup is required to be moved to another recording region of the optical disc 17; however, it usually takes 1 second or less for the pickup to move, so that there is still sufficient time for the recording of the data in the other memory region.

By repeating this operation, two broadcasting programs can be simultaneously recorded. Further, in some cases, the above method enables simultaneous recording of three broadcasting programs or greater. The system control section 11 controls such a series of flows of (i) the receipt of the data from a plurality of tuners, (ii) the data allocation in the buffer memory 20, (iii) the recording of the data onto the optical disc 17 from the buffer memory 20.

The following explains a case where one broadcasting program is immediately recorded by pressing a recording button before recording of another broadcasting program scheduled to be recorded. In this case, the user recognizes a length of recording time of the broadcasting program scheduled to be recorded, but possibly does not recognize estimated picture recording finish-time of the manually recorded broadcasting program, or possibly does not decide when to finish the recording in advance.

The easiest way for acquiring such estimated picture recording finish-time is to use the EPG so as to acquire estimated finish-time of the broadcasting program, and the recording is so set as to be terminated at the estimated finish-time thus acquired. An alternative way is that the optical disc recording/reproducing apparatus 10 requires the user to input such picture recording finish time. As such, even in cases where the recording of the broadcasting program is started prior to the recording of the broadcasting program scheduled to be recorded, the recording time of the broadcasting program that has started to be recorded is acquired. This also allows data of the broadcasting program to be recorded onto a continuous recording region in the disc.

Note that the present invention is applicable not only to a method for securing the recording region of the optical disc 17 for each broadcasting program, but also to a method for securing the recording region of the optical disc 17 based on category of broadcasting programs to be recorded. Examples of the category include a movie, a sport, a drama, and the like. In this case, the broadcasting programs are required to be classified in accordance with the category, but the use of the aforementioned EPG allows automatic classification of the broadcasting programs. Using the disc in this way is ineffective to some extent; however, in cases where a disc allowing sufficiently long recording is used, a sufficient storage capacity can be secured even after dividing the recording region of the disc in accordance with the category. A specific example of such a disc allowing sufficiently long recording is a next generation high density optical disc BD (Blu-ray Disc) having a one-side recording volume of 25 GB through 50 GB.

Further, in cases where a single-sided dual (double) layer disc is used for the simultaneous recording of a plurality of broadcasting programs, it is not preferable to secure a recording region continuing over the two layers. A reason for this is as follows. That is, in cases where a region continuing from a first layer to a second layer is secured, the pickup is required to travel from an outermost side of the recording region to an innermost side thereof after the pickup instantly changes target layers to be read out. For this reason, it is desirable to secure a continuous region in each recording layer of the recording medium having two recording layers.

However, some broadcasting program is possibly so long that only one layer is not enough for storing the broadcasting program. In this case, the optical disc recording/reproducing apparatus 10 is set such that a broadcasting program is recorded over the two layers. For example, in cases where a three-hour broadcasting program is recorded onto a disc having layers each capable of storing data corresponding to two hours, a second layer is used for the sake of attaining continuous recording and continuous reproduction of the broadcasting program.

Using the dual layer recording medium in this way possibly requires expansion of the buffer memory. However, in the second layer, an estimated terminated address of the broadcasting program is determined on this occasion, so that a recording start position of a next broadcasting program may be set at a position coming after the estimated terminated address. In cases where the recording medium has a third recording layer, the optical disc recording/reproducing apparatus 10 may be set such that a next recording of a broadcasting program is started from the third layer.

Further, in cases where two broadcasting programs are recorded at the same time, each of the broadcasting programs can be recorded onto each recording layer from the start of the recording. Moreover, in cases where recording of two broadcasting programs onto a blank disc is started at the same time, a radial-direction recording position in the one recording layer corresponds to a radial-direction recording position in the other recording layer. The recording of the broadcasting programs is carried out in such a manner that recording of a part of one broadcasting program and recording of a part of the other broadcasting program take turns. Therefore, in order to find and carry out recording with respect to a target recording position (address), the pickup merely changes a focus on the recording layers, with the result that the seeking operation is not required in most cases.

Further, a plurality of broadcasting programs can be simultaneously reproduced while simultaneously recording the broadcasting programs. In this case, when the optical disc recording/reproducing apparatus 10 has two or more moving image output systems 19 (an external output 1 and an external output 2), the broadcasting programs may be respectively allocated to the external outputs 1 and 2, or data corresponding to the broadcasting programs are sent to the external output 1 such that two broadcasting programs are displayed individually on a display screen divided in two.

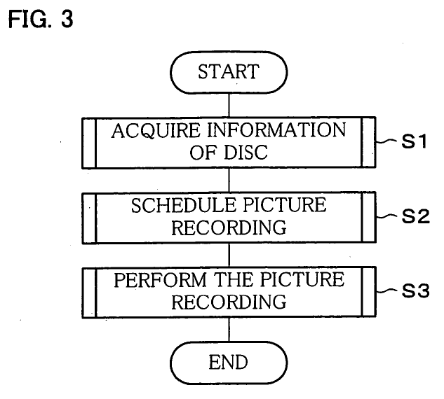

Next, the following description explains a process (hereinafter, referred to as “picture recording control process”) of the above operation carried out as the control operation of the system control section 11, with reference to FIG. 3 through FIG. 6.

As shown in FIG. 3, the picture recording control process includes (i) a disc information acquirement process (step S1; hereinafter, also referred to as simply “S1”, and this is true of the other steps) of acquiring information of the optical disc 17; (ii) a picture recording scheduling process (S2) of scheduling picture recording; and (iii) a picture recording performing process (S3) of performing picture recording. Hereinafter, each of the processes is explained.

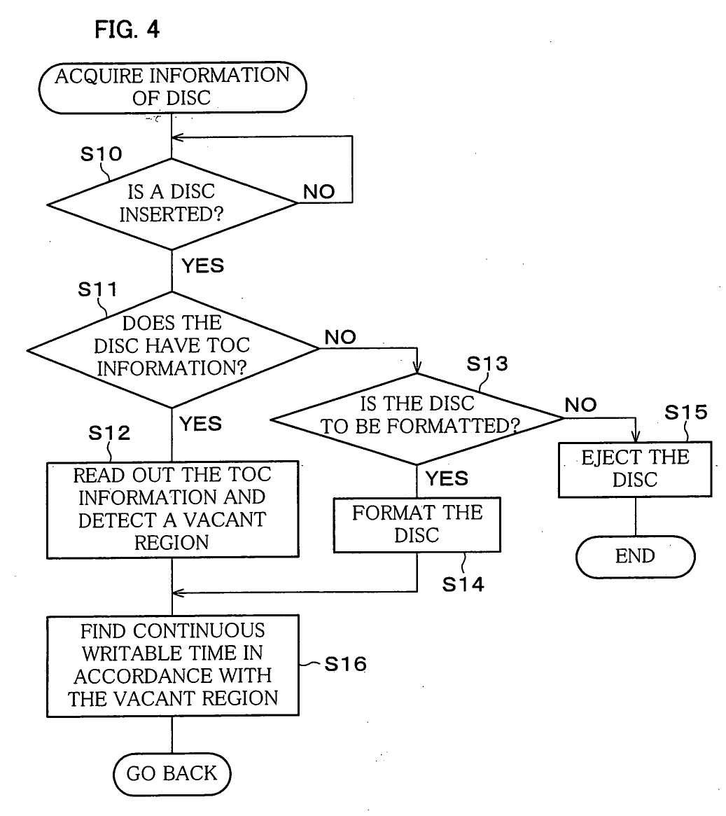

As shown in FIG. 4, in the disc information acquirement process, the system control section 11 stands by until insertion of the optical disc 17 (S10). When the optical disc 17 is in the optical disc recording/reproducing apparatus 10, or when the optical disc 17 is inserted, the disc ID detection section 16 detects the unique disc ID.

The disc ID is unique because the disc ID contains information such as a manufacture date of the optical disc 17, a manufacturer thereof, and a serial number thereof. The disc ID can be used as follows together with various types of disc information, such as a title of the broadcasting program, about contents data stored in the optical disc 17. For example, such disc information is stored in a memory apparatus of the optical disc recording/reproducing apparatus 10 so that the disc information and the disc ID are correlated with each other. When the disc ID is detected by the disc ID detection section 16, the disc information correlated with the disc ID is accordingly read out. This makes it possible to provide the user with the disc information in various forms.

Thereafter, the system control section 11 judges whether or not the optical disc 17 has TOC (Table of Contents) information (S11). Generally, a recording status of the optical disc 17 is stored in the TOC information. Therefore, reference to the TOC information allows recognition of vacant capacity in the optical disc 17, and of data allocation state therein.

In cases where the optical disc 17 has such TOC information, detection of the vacant region is carried out in reference to the TOC information read out from the optical disc 17 (S12). Then, the sequence goes to a step S16.

On the other hand, in cases where the optical disc 17 does not have such TOC information, i.e., where the optical disc 17 is not a formatted disc or is a disc formatted in accordance with a special format, the vacant region in the optical disc 17 cannot be detected, so that the user is caused to decide whether or not formatting of the optical disc 17 is to be done (S13).

In cases where the user decides that the formatting is to be done, the formatting of the optical disc 17 is carried out (S14). Upon the formatting, the vacant region in the optical disc 17 is detected. When the formatting is completed, the sequence goes to the step S16.

On the other hand, in cases where the formatting is not to be done, the vacant region of the optical disc 17 cannot be detected. Therefore, the optical disc 17 is ejected (S15), and then the picture recording control process is terminated.

Next, calculation is carried out so as to find recording time of the data that is to be continuously recorded onto the vacant region, in accordance with the capacity of the vacant region (S16). (Hereinafter, the recording time is referred to as “continuous writable time (recordable data input time).”) Thereafter, the sequence goes back to the picture recording control process shown in FIG. 3. For example, in cases where the vacant region has a recording capacity (capacity capable of storage of only moving image information) of 2.25 GB (Gigabytes), and where the optical disc recording/reproducing apparatus 10 receives broadcasting data including a moving image at a constant rate of 5 Mbps, the continuous writable time is found by the following equation: 2.25×10³×8/5=3600 seconds=1 hour.

Note that there are two methods for use in such moving image recording: (i) a constant transfer rate method in which the data transfer rate of the moving image is fixed at a predetermined value, and (ii) a variable transfer rate method in which the data transfer rate is variable depending on an image. In the variable transfer rate method, the transfer rate is converged in average data transfer rate as long as the continuous writable time is sufficiently long; however, some image possibly exceeds assumed capacity. In consideration of this, it is desirable that recording time be long to some extent in cases where the variable transfer rate method is adopted.

Further, even in cases where data corresponding to a broadcasting program are separately stored in two or three recording regions because of insufficient continuous capacity in the vacant region, the buffer memory 20 having a sufficient memory capacity as above still sufficiently allows the recording.

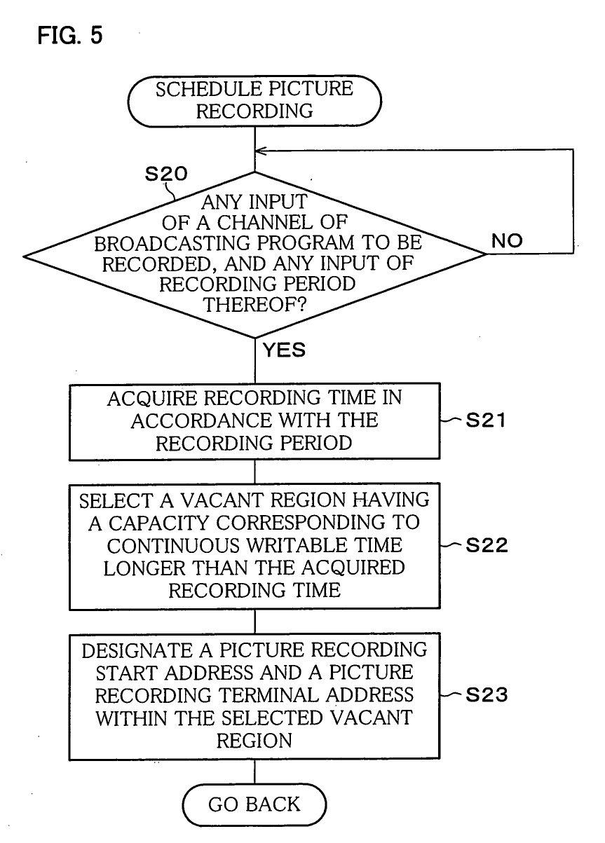

After the end of the disc information acquirement process, the picture recording scheduling process (see FIG. 5) is carried out. Firstly, the system control section 11 stands by until the user inputs, via the user operation section 14, (i) a channel of a broadcasting program to be recorded, and (ii) a period during which the broadcasting program will be recorded (S20).

In response to the input of the channel and the period, the system control section 11 acquires recording time (data input time) in accordance with the input period during which the broadcasting program will be recorded (S21). Next, in reference to the continuous writable time, found in the disc information acquirement step shown in FIG. 3, of each vacant region, the system control section 11 selects a vacant region having continuous writable time longer than the recording time acquired in the step S21 (S22). Here, in cases where a plurality of regions are selected, the selection may be carried out in accordance with (i) a capacity (a region having a capacity close to the required volume, or a region having the largest capacity), and (ii) an address (a region closest to a first region in terms of traveling time of the pickup).

Next, the system control section 11 designates, in accordance with the recording time, a recording start address (position) and a recording terminal address within the selected vacant region (S23). Thereafter, the sequence goes back to the picture recording control process shown in FIG. 3.

Note that, in cases where recording of a broadcasting program is carried out immediately by pressing a recording button, the step S20 shown in FIG. 5 is replaced with a step of acquiring estimated recording finish-time, by requiring the user to input when to finish the recording or in reference to the EPG. The other steps (S21 to S23) are carried out in the similar manner. This allows the acquirement of the recording time, and accordingly allows determination of the recording start address and the recording terminal address in the optical disc 17.

Further, in cases where recording of a broadcasting program A is started just before a start of recording of a broadcasting program B, it is preferable that a recording start address of the broadcasting program B be designated in a position located in a downstream side with respect to a recording terminal address of the broadcasting program A. For example, in an optical disc 17 in which data recording is started from an inner side thereof, it is preferable that the recording of the broadcasting program B be carried out from a position located in a circumferential (outer) side with respect to the estimated terminal position of the broadcasting program A. In this case, the recording start address of the broadcasting program B can be found in accordance with the recording terminal address of the broadcasting program A. Note that the recording terminal address of the broadcasting program B can be found in accordance with the recording time of the broadcasting program B, as is the case with the broadcasting program A.

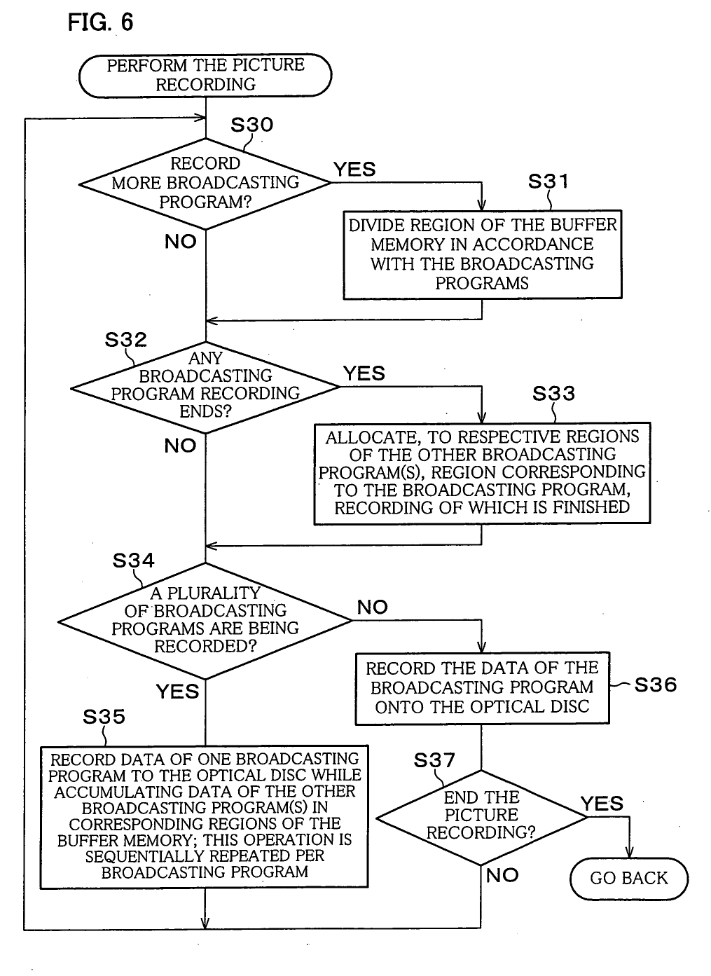

After the end of the picture recording scheduling process, the picture recording performing process shown in FIG. 6 is carried out. Firstly, the system control section 11 judges whether or not recording of another broadcasting program is to be further carried out (S30). In cases where another broadcasting program is to be further recorded, the memory region of the buffer memory 20 is divided for each of the broadcasting programs (S31). Next, the system control section 11 judges whether or not recording of any of the broadcasting programs is finished (S32). When finishing recording of a broadcasting program, the system control section 11 writes, in a TOC, recording information of the broadcasting program; and releases the memory region, corresponding to the broadcasting program whose recording is finished, of the buffer memory 20 so as to allocate the released memory region to the memory region(s) corresponding to the other broadcasting program(s) (S33).

Next, the system control section 11 judges whether or not a plurality of broadcasting programs are simultaneously recorded (S34). In cases where a plurality of broadcasting programs are simultaneously recorded, data corresponding to one broadcasting program are recorded while accumulating data, corresponding to the other broadcasting program(s), in each memory region of the buffer memory 20, this operation being sequentially carried out with respect to each target broadcasting program (S35).

On the other hand, in cases where a plurality of broadcasting programs are not simultaneously recorded, i.e., where only one broadcasting program is recorded, data corresponding to the broadcasting program is recorded onto the optical disc 17 (S36). Next, the system control section 11 judges whether or not the picture recording is to be finished (S37). When finishing the recording of the broadcasting program, the system control section 11 writes recording information in the TOC. Then, the sequence goes back to the picture recording control process shown in FIG. 3, and the picture recording control process is completed.

On the other hand, in cases where the recording of the broadcasting program is not finished after the step S35 or in the step S37, the sequence goes back to the step S30, and the above operations are repeated.

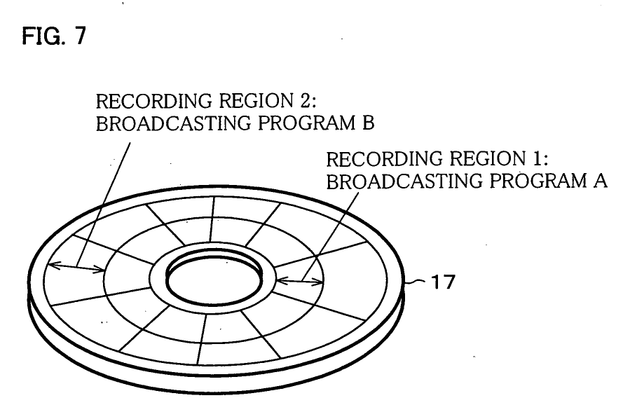

FIG. 7 illustrates an example of the optical disc 17 with respect to which the recording was carried out by carrying out the above operations. As shown in FIG. 7, the terminal position of the broadcasting program A never overlaps with the start position of the broadcasting program B. Moreover, the data corresponding to the broadcasting programs are recorded onto continuous recording regions, respectively. With this, the pickup carries out the seeking operation only when traveling from one recording region to a recording halt point of the other recording region so as to simultaneously record the two broadcasting programs. This minimizes the seeking operation of the pickup, thereby enabling the broadcasting program simultaneous recording using the buffer memory 20.

As such, upon the simultaneous recording of two broadcasting programs, the above method allows minimization of (i) the seeking operation of the pickup, and (ii) the time taken for the seeking operation. This allows, for example, reduction of the volume of the buffer memory 20. If data corresponding to one broadcasting program were permitted to be separately stored in a plurality of positions, the seeking operation of the pickup would be more frequent upon the simultaneous recording and the simultaneous reproduction of a plurality of broadcasting programs. This would cause increase of time required for operation other than the recording operation. This would possibly cause overflow of the buffer memory 20 for temporarily storing the data corresponding to the broadcasting programs that are being simultaneously recorded or reproduced. Accordingly, the simultaneous reproduction, the simultaneous recording, time-shift reproduction, and the like possibly would not be able to be carried out.

As such, in the recording apparatus capable of simultaneous recording of two broadcasting programs, the recording of each broadcasting program onto the optical disc 17 in a continuous manner allows (i) effective use of the buffer memory 20, and (ii) prevention of the recording failure due to the overflow of the buffer memory 20. Moreover, the buffer memory 20 is also effectively used upon reproduction of the optical disc 17 having the data recorded in accordance with the above recording method. Specifically, the buffer memory 20 ensures, for example, (i) reproduction during recording, and (ii) simultaneous reproduction of a plurality of broadcasting programs.

Note that the present invention can be implemented by using a program that causes a computer to carry out the aforesaid processes of the data recording method, and that is stored in a computer-readable recording medium. With this, the program for causing a computer to carry out the data recording method can be freely provided by way of such a portable recording medium storing the program.

Examples of such a recording medium (program medium) may include: (i) a memory (not shown), such as a ROM (read only memory), for processing using a microcomputer; and (ii) a recording medium (program medium) that can be read by a program readout apparatus (not shown), serving as an external memory apparatus, when the recording medium is inserted in the program readout apparatus.

Further, in any case, it is preferable that the stored program be so configured as to be executed by access of the microprocessor. Further, it is preferable if the contained program is accessible to a microprocessor which will execute the program. Further, it is preferable if the program is read, and the program is then downloaded to a program storage area of a microcomputer where the program is executed. Assume that the program for download is stored in a main body device in advance.

Note also that the program medium is a recording medium detachable from the main body, and holds the program in a fixed manner. Examples of the recording medium includes: (i) tapes such as a magnetic tape and a cassette tape; (ii) magnetic disks such as a floppy® disk and a hard disk; (iii) disks such as a CD-ROM (compact disk read only memory), a magnetic optical disk (MO), a mini disk (MD), a DVD; (iv) cards such as an IC card (including a memory card) and an optical card; or (v) a semiconductor memory such as a mask ROM, an EPROM (electrically programmable read only memory), EEPROM (electrically erasable programmable read only memory), and a flash ROM. Furthermore, the storage medium may be a memory provided within the calculating means such as a CPU.

Alternatively, if a system can be constructed which can connects to the Internet or other communications network, it is preferable if the program medium is a storage medium carrying the program in a flowing manner as in the downloading of a program over the communications network.

Further, when the program is downloaded over a communications network in this manner, it is preferable if the program for download is stored in a main body device in advance or installed from another storage medium.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

For example, explanation of the aforementioned embodiment uses the optical disc 17, such as a DVD, as the recording medium; however, the recording medium may be any random accessible recording medium such as: (i) an optical magnetic disk like a MO (Magneto Optical Disk); and (ii) a magnetic disk like a HD (Hard Disk).

Further, the contents data is a mere example of data to be recorded onto the optical disc 17, so that this is not only data to be recorded onto the optical disc 17.

Further, instead of finding the continuous writable time based on the vacant region in the step S16 shown in FIG. 4, in the step S22 shown in FIG. 5, the system control section 11 may find a required recording capacity for storing the broadcasting program in accordance with the acquired recording time, and may select a vacant region having a recording capacity larger than the required recording capacity thus found.

Further, instead of the buffer memory 20, there may be used a HDD having access speed faster than that of the optical disc 17.

Further, as embodiment of the present invention, the present invention can be arranged as follows.

The aforesaid broadcasting program recording method using the recording apparatus is a method for simultaneously recording a plurality of broadcasting program received from a plurality of sources, and the method can include the steps of: (i) detecting, in accordance with a recording start time and recording finish time information, whether or not there is a period during which broadcasting programs are to be simultaneously recorded; (ii) in cases where there is the period, selecting, as a first broadcasting program, a broadcasting program whose recording start time is the earliest, and selecting, as a second broadcasting program, a broadcasting program whose recording start time is the second earliest; (iii) acquiring recording start address information of the first broadcasting program, and recording time of the first broadcasting program; (iv) calculating recording terminal address information of the first broadcasting program in accordance with the recording start address information and the recording time; and (v) determining a recording start address of the second broadcasting program in accordance with the recording terminal address.

With the above method, control means such as a CPU detects, in accordance with the recording information stored in memory means such as a memory, whether or not there are recording programs to be simultaneously recorded. More specifically, the control means extracts the broadcasting programs to be recorded, in accordance with information such as respective recording start times and respective (estimated) recording finish times of the broadcasting programs.

In cases where the extracting finds that there are the broadcasting programs to be simultaneously recorded, the control means compares respective recording start times of the broadcasting programs, and sets, as the first broadcasting program, the broadcasting program whose recording start time is the earliest, and sets, as the second broadcasting program, the broadcasting program whose recording start time is the second earliest. Note that in cases where the broadcasting programs have the same recording start time, the broadcasting program firstly scheduled to be recorded is regarded as the first broadcasting program.

The control means acquires the recording time of the first broadcasting program, in accordance with the recording schedule information. For example, the recording time can be found by subtracting the recording start time from the recording finish time. Moreover, the control means acquires a recording start position (address) in accordance with the recording information of the recording medium such as an optical disc.

Note that, in cases where the variable rate method is adopted, for the recording of the broadcasting program, as an encoding method for converting analog data of the terrestrial broadcasting into digital data for the DVD or the like, average transfer rate can be set but the recording finish position is likely to be changed. In consideration of this, a recording finish position of the second broadcasting program is required to be provided with an appropriate margin. The variable rate method refers to such a method that data transfer rate is high while transmitting data corresponding to an active motion scene, and that data transfer rate is low while transmitting data corresponding to a less active motion scene.

Further, recording/reproducing rate can be controlled such that each broadcasting program is contained within a storage (recording) capacity of a predetermined recording region. For example, the broadcasting program can be contained within the predetermined storage capacity by changing the transfer rate in accordance with a remaining storage capacity which is always calculated or is calculated every predetermined time (e.g., five minutes).

Next, the control means converts the calculated recording time into storage capacity so as to find the recording finish position (address) of the first broadcasting program. Finally, the control means determines the recording start position of the second broadcasting program in accordance with the broadcasting finish position of the first broadcasting program. At the recording start time of the second broadcasting program, recording is started from the recording start position thus determined.

As such, the recording finish position of the broadcasting program to be firstly recorded is found by the calculation, and the recording start position of the second broadcasting program is determined in accordance of the recording finish position thus found. With this, the recording data of the first broadcasting program is never separated, in the optical disc, by the recording data of the second broadcasting program.

Therefore, during the simultaneous picture recording of the first and second broadcasting programs, respective data of the first and second broadcasting programs can be continuously recorded by recording the data of the first broadcasting program continuously from the recording start address of the first broadcasting program, and by recording the data of the second broadcasting program continuously from the recording start address of the second broadcasting program.

With this, data of one broadcasting program (contents) is never separately stored in the optical disc, so that the recording region can be effectively used.

Further, the method and the recording apparatus, capable of the simultaneous recording of the broadcasting programs, make it possible to determine a broadcasting program recording start position in the medium such that data of a broadcasting program to be recorded is never separated but is continuously recorded.

With this, even when two broadcasting programs are simultaneously recorded, each broadcasting program is recorded as a continuous file. Therefore, the pickup never carries out any seeking operation and any round trip operation as long as the broadcasting program is continuously reproduced. This allows reduction of the capacity of the buffer memory for temporarily storing moving image information of one broadcasting program that is being recorded onto the medium. Accordingly, cost of the apparatus is reduced.

Further, the frequency of the round trip of the pickup is never increased upon the simultaneous recording of a plurality of broadcasting programs, so that the picture recording never fails by the overflow of the moving image data in the buffer memory due to the seeking operation and the round trip operation of the pickup. Moreover, in cases where another broadcasting program is caused to be further recorded during recording of one broadcasting program, a recording start position of the broadcasting program thus caused to be further recorded can be determined in accordance with broadcasting time information of the broadcasting program, which broadcasting time information is acquired by, e.g., using the EPG.

Further, the recording apparatus capable of simultaneous recording of a plurality of broadcasting programs may be arranged such that broadcasting programs corresponding to a certain subject matter (content) can be continuously stored in a recording region determined in advance.

With this, the recording region is determined based on the subject matter, such as drama, sport, and movie, of the broadcasting program. This allows the broadcasting programs to be stored in the respective separate regions thus set in advance. With such regions secured in advance, the start position of the broadcasting program is not required to be found in accordance with respective recording times of the other broadcasting program(s). The subject matter of the broadcasting program is included in the EPG information, so that the use of the EPG is effective when adding a broadcasting program to be recorded.

Further, the apparatus capable of carrying out recording with respect to a plurality of layers of an disc-shaped recording medium may be arranged such that: when recording of a plurality of broadcasting programs are set to be carried out at the same time, the broadcasting programs are recorded onto respective secured continuous regions in different layers.

In the case of using such a medium having the layers, the pickup never changes target layers while recording at least one broadcasting program. In other words, no track jump and no target layer change are carried out while recording one broadcasting program. This increases efficiency of using the buffer memory, with the result that the equipped memory can be reduced. Accordingly, drive cost can be reduced.

Further, the method of the present invention may be arranged such that: the recording apparatus includes temporary memory means for temporarily storing partial data, which is a part of the data to be recorded onto the recording medium, and the step (c) includes the step of: (d) allocating memory regions of the temporary memory means to the data, respectively, when the plurality of data are simultaneously supplied to said recording apparatus so as to be recorded.

Here, a typical example of such a temporary memory means is a buffer memory; however, it is possible to use an arbitrary memory apparatus or recording apparatus, each of which has faster access speed, faster writing speed, and faster readout speed as compared with the recording medium. For example, in cases where the recording medium is an optical disc, the temporary memory means can be a hard disk and a semiconductor memory such as a DRAM (Dynamic Random Access Memory), each of which has faster access speed, faster writing speed, and faster readout speed as compared with the optical disc.

The method allows the memory region of the temporary memory means to be allocated to each data. With this, while recording a part of any data onto the recording medium, a part of the rest of the data can be temporarily stored in the temporary memory means. Therefore, loss of the other data simultaneously received can be prevented by arranging the recording apparatus such that: data is read out prior to occurrence of overflow of the data in the temporary memory means so as to be recorded onto the recording medium. This further surely prevents failure of the recording of the data.

Further, the method of the present invention further includes the steps of: (e) calculating recordable data input time of each of the continuous vacant regions detected in the (a) step, which recordable data input time is time required for the data which are inputted to the recording apparatus and correspond to the vacant region; and (f) acquiring data input time during which the data are inputted to the recording apparatus, wherein: in the step (b), a vacant region having recordable data input time longer than the data input time is selected for each of the data in accordance with (i) the recordable data input time calculated in the step (e), and (ii) the data input time acquired in the step (f).

For example, in cases where the data is broadcasting program data of a television broadcasting or the like, and where the data is acquired by programming (scheduling) recording of the broadcasting program, it is easier to acquire, by way of the EPG, broadcasting time of the broadcasting program, as compared with acquirement of data amount of the broadcasting program. Specifically, it is easier to acquire distribution time, transmitting time, or broadcasting time of the broadcasting program distributed, transmitted, or broadcasted from various information media, as compared with acquirement of the data amount of the data. As such, in some cases, it is easier to acquire the data input time than the data amount of the data to be received by the recording apparatus.

In light of this, in the step (e) of the method, the recording capacity of the vacant region is converted into the practicable data input time in accordance with, e.g., the transmitting speed of the broadcasting program data transmitted from the aforesaid information media, i.e., in accordance with the input rate of the data sent to the recording apparatus. Moreover, selected for each of the data in the step (b) is the vacant region corresponding to the practicable data input time longer than the data input time. For example, in cases where the data is contents data such as moving image and sound, the practicable data input time can be found by dividing the recording capacity of the vacant region with the transmitting speed (input rate) of the data. In other words, the vacant region is selected in accordance with the data input time, so that this is beneficial when it is easy to acquire the information about the data input time.

Further, the method of the present invention may be arranged such that: in the step (b), the selection of the respective vacant regions for the simultaneously inputted data is carried out such that data to be recorded later is recorded onto a vacant region located in a downstream side with respect to a vacant region for data to be recorded earlier.

With the method, the firstly received data of the data simultaneously sent to the recording apparatus is recorded onto a vacant region located in a upstream side, and the later received data thereof is recorded onto the vacant region located in the downstream side. This allows sequential recording of the data, from the upstream side, onto the vacant regions of the recording medium. Accordingly, each vacant region is less likely to be small, and is less likely to be separated, with the result that the data can be effectively recorded onto the recording medium. Note that the present invention is especially effective in a case that all the recording regions are vacant regions, as in a recording medium just after being formatted. A specific example of the data simultaneously sent to the recording apparatus is broadcasting data simultaneously transmitted from a plurality of information media.

Further, the method of the present invention further includes the steps of: (g) allocating the vacant regions detected in the step (a), in accordance with a category of the data; and (h) acquiring the category of the inputted data, wherein: in the step (b), the vacant region having the recording capacity larger than the data size of each of the data is selected, for each of the data, from the vacant regions allocated in the step (g) in accordance with the category, acquired in the step (h), of the data.

Here, examples of the category of the data include broadcasting program contents such as news, sport, drama, documentary, and movie, in cases where the data is broadcasting program data of television broadcasting or the like. Moreover, the data can be classified in accordance with inputs such as the terrestrial broadcasting tuner and the BS tuner.

Incidentally, data readout is usually carried out in accordance with the category of the data, rather than in a recorded order.

With the above method, data falling within the same category are recorded onto recording regions close to each other, so that the data readout can be carried out efficiently.

The method of the present invention may be arranged such that: in the step (a), in cases where the recording medium has a plurality of recording layers, the continuous vacant regions are detected in each of the layers of the recording medium.

With the method, the data is recorded onto a continuous vacant region in a certain recording layer, so that the data is never recorded onto a vacant region continuing over the recording layers. With this, the pickup does not carry out the seeking operation within the recording region where the data recording is carried out. This surely prevents the recording failure of the simultaneously received data.

Further, the method of the present invention may be arranged such that: in the step (b), the vacant regions are selected from vacant regions in a different layer.

With the method, the simultaneously received data are recorded onto the recording layers, respectively.

Incidentally, in cases where a plurality of data are recorded onto a single recording layer, the pickup records a part of the data onto a continuous recording region, and then is caused to move to another recording region across the continuous recording region so as to record a part of another data thereonto.

On the other hand, in cases where a plurality of data are respectively recorded onto a plurality of recording layers, the pickup records a part of data onto a continuous recording region in one recording layer, and then is subjected to adjustments for the target layer change such that the pickup is able to carry out recording with respect to another recording layer, and is caused to move to a continuous recording region of the recording layer so as to record a part of another data thereonto. Examples of the adjustments include: a laser power adjustment and aberration correction.

In other words, although time taken for the adjustment is required to be considered, the recording of a plurality of the data onto the respective recording layers possibly allows reduction of traveling amount of the pickup upon the seeking operation, as compared with the recording of a plurality of the data onto the single recording layer. Accordingly, time taken for the seeking operation is reduced. This further surely prevents the recording failure of the simultaneously received data.

For example, in cases where the recording medium is an optical disc, such as a DVD, which has a plurality of recording layers, what are required are: time for the pickup to focus on another recording layer, and the adjustment time. Even so, the traveling amount of the optical pickup is reduced, upon the seeking operation after changing target layers for the recording, by carrying out control such that a recording position in a radial direction of one layer substantially corresponds to a recording position in the radial direction of the other layer(s). Accordingly, the time taken for the seeking operation is reduced. This further surely prevents the recording failure of the simultaneously received data.

Note that the aforesaid method is more effective when the pickup jumps longer distance over the continuous recording region in cases where the plural data are recording onto the single recording layer. Therefore, as described above, the method is effective when the data has an extremely long data length. A specific example of such data is contents data such as image and sound.

Further, the recording apparatus further includes: temporary memory means for temporarily storing partial data, which is a part of the data to be recorded onto the recording medium, wherein: the recording control means includes allocating means for allocating memory regions of the temporary memory means to the data, respectively, when the data are simultaneously supplied to said recording apparatus so as to be recorded.

The structure allows the memory region of the temporary memory means to be allocated to each data. With this, while recording a part of any data onto the recording medium, a part of the rest of the data can be temporarily stored in the temporary memory means. Therefore, loss of the other data simultaneously received together can be prevented by arranging the recording apparatus such that: data is read out prior to occurrence of overflow of the data in the temporary memory means so as to be recorded onto the recording medium. This further surely prevents failure of the recording of the data.

Further, the recording apparatus of the present invention further includes: calculating means for calculating recordable data input time of each of the continuous vacant regions detected by the detecting means, which recordable data input time is time required for the data which are inputted to the recording apparatus and correspond to the vacant region; and

acquiring means for acquiring data input time during which the data are inputted to the recording apparatus, wherein: the selecting means selects, for each of the data, a vacant region having recordable data input time longer than the data input time, in accordance with (i) the recordable data input time calculated by the calculating means, and (ii) the data input time acquired by the acquiring means.

With the structure, the calculating means converts the recording capacity of the vacant region into the practicable data input time, and the selecting means select, for each of the data, the vacant region corresponding to the practicable data input time longer than the data input time. In other words, the vacant region is selected in accordance with the data input time, so that this is beneficial when it is easy to acquire the information about the data input time.

Further, the recording apparatus of the present invention may be arranged such that: the selecting means selects the respective vacant regions for the simultaneously inputted data such that data to be recorded later is recorded onto a vacant region located in a downstream side with respect to a vacant region for data to be recorded earlier.

With the structure, the firstly received data is recorded onto the vacant region located in a upstream side, and the later received data is recorded onto the vacant region located in the downstream side. This allows sequential recording of the data, from the upstream side, onto the vacant regions of the recording medium. Accordingly, a vacant region is less likely to be small, and is less likely to be separated, with the result that the data can be effectively recorded onto the recording medium. Note that the present invention is especially effective in a case that all the recording regions are vacant regions, as in a recording medium just after being formatted.

Further, the recording apparatus of the present invention further includes: vacant region allocating means for allocating the vacant regions detected by the detecting means, in accordance with a category of the data; and data category acquiring means for acquiring the category of the inputted data, wherein: the selecting means selects the vacant region having the recording capacity larger than the data size of each of the data, the selecting being carried out, for each of the data, from the vacant regions allocated by the vacant region allocating means in accordance with the category, acquired by the data category acquiring means, of the data.

With the structure, data falling within the same category are recorded onto recording regions close to each other, so that the data readout can be carried out efficiently.

Further, the recording apparatus of the present invention may be arranged such that: in cases where the recording medium has a plurality of recording layers, the detecting means detects the continuous vacant regions in each of the layers of the recording medium.

With the structure, the data is recorded onto a continuous vacant region in a certain recording layer, so that the data is never recorded onto a vacant region continuing over the recording layers. With this, the pickup does not carry out the seeking operation within the recording region where the data recording is carried out. This surely prevents the recording failure of the simultaneously received data.

Further, the recording apparatus of the present invention may be arranged such that: the selecting means selects the vacant regions from vacant regions in a respective layer.

With the structure, the simultaneously received data are recorded onto the recording layers, respectively. In this case, as described above, the traveling amount of the pickup upon the seeking operation is possibly reduced as compared with the recording of a plurality of the data onto the single recording layer. Accordingly, time taken for the seeking operation is reduced. This further surely prevents the recording failure of the simultaneously received data.

For example, in cases where the recording medium is an optical disc, such as a DVD, which has a plurality of recording layers, what are required are: time for the pickup to focus on another recording layer, and the adjustment time. Even so, the traveling amount of the optical pickup is reduced, upon the seeking operation after changing target layers for the recording, by carrying out control such that a recording position in a radial direction of one layer substantially corresponds to a recording position in the radial direction of the other layer(s). Accordingly, the time taken for the seeking operation is reduced. This further surely prevents the recording failure of the simultaneously received data.

Note that, as described above, the structure is effective when the data has an extremely long data length. A specific example of such data is contents data such as image and sound.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

As described above, the data recording method using the recording apparatus, the recording apparatus thereof, the data recording program, and the recording medium storing the data recording program, each of which is according to the present invention, allow prevention of the failure of recording a plurality of the simultaneously received data onto the recording medium.

Therefore, the present invention is suitably used in a manufacture industry of a recording apparatus using a random accessible recording medium such as: an optical disc such as a DVD and a BD, an optical magnetic disk such as an MO, and a magnetic disk such as a HD.

1. A method for recording a plurality of data, at least a part of which are simultaneously received, onto a recording medium with the use of a recording apparatus for recording the data, the method comprising the steps of:
(a) detecting continuous vacant regions in the recording medium;
(b) selecting, from the detected vacant regions, for each of the data, at least one vacant region having a recording capacity larger than data size of said each of the data; and
(c) recording corresponding data onto the selected vacant regions, respectively.

2. The method as set forth in claim 1, wherein:
the recording apparatus includes temporary memory means for temporarily storing partial data, which is a part of the data to be recorded onto the recording medium, and
the step (c) includes the step of:
(d) allocating memory regions of the temporary memory means to the data, respectively, when the plurality of data are simultaneously supplied to said recording apparatus so as to be recorded.

3. The method as set forth in claim 1, wherein:
the recording medium has TOC information, and the continuous vacant regions are obtained, in the (a) step, in accordance with the TOC information.

4. The method as set forth in claim 1, further comprising the steps of:
(e) calculating recordable data input time of each of the continuous vacant regions detected in the (a) step, which recordable data input time is time required for the data which are inputted to the recording apparatus and correspond to the vacant region; and
(f) acquiring data input time during which the data are inputted to the recording apparatus, wherein:
in the step (b), a vacant region having recordable data input time longer than the data input time is selected for each of the data in accordance with (i) the recordable data input time calculated in the step (e), and (ii) the data input time acquired in the step (f).

5. The method as set forth in claim 4, wherein:
in the step (f), the data input time is acquired in accordance with EPG information.

6. The method as set forth in claim 1, wherein:
in the step (b), the selection of the respective vacant regions for the simultaneously inputted data is carried out such that data to be recorded later is recorded onto a vacant region located in a downstream side with respect to a vacant region for data to be recorded earlier.

7. The method as set forth in claim 1, further comprising the steps of:
(g) allocating the vacant regions detected in the step (a), in accordance with a category of the data; and
(h) acquiring the category of the inputted data, wherein:
in the step (b), the vacant region having the recording capacity larger than the data size of each of the data is selected, for each of the data, from the vacant regions allocated in the step (g) in accordance with the category, acquired in the step (h), of the data.

8. The method as set forth in claim 7, wherein:
in the step (h), the category of the data is acquired in accordance with EPG information.

9. The method as set forth in claim 1, wherein:
in the step (a), in cases where the recording medium has a plurality of recording layers, the continuous vacant regions are detected in each of the layers of the recording medium.

10. The method as set forth in claim 9, wherein:
in the step (b), the vacant regions are selected from vacant regions in a different layer.

11. A recording apparatus for recording a plurality of data, at least a part of which are simultaneously received, onto a recording medium, the recording apparatus comprising:
detecting means for detecting continuous vacant regions in the recording medium;
selecting means for selecting, from the detected vacant regions, for each of the data, at least one vacant region having a recording capacity larger than data size of said each of the data; and
recording control means for recording corresponding data onto the selected vacant regions, respectively.

12. The recording apparatus as set forth in claim 11, further comprising:
temporary memory means for temporarily storing partial data, which is a part of the data to be recorded onto the recording medium,
wherein:
the recording control means includes allocating means for allocating memory regions of the temporary memory means to the data, respectively, when the data are simultaneously supplied to said recording apparatus so as to be recorded.

13. The recording apparatus as set forth in claim 11, wherein:
the recording medium includes TOC information, and the detecting means detects the continuous vacant regions in accordance with the TOC information.

14. The recording apparatus as set forth in claim 11, further comprising:
calculating means for calculating recordable data input time of each of the continuous vacant regions detected by the detecting means, which recordable data input time is time required for the data which are inputted to the recording apparatus and correspond to the vacant region; and acquiring means for acquiring data input time during which the data are inputted to the recording apparatus, wherein:
the selecting means selects, for each of the data, a vacant region having recordable data input time longer than the data input time, in accordance with (i) the recordable data input time calculated by the calculating means, and (ii) the data input time acquired by the acquiring means.

15. The method as set forth in claim 14, wherein:
the acquiring means acquires the data input time in accordance with EPG information.

16. The recording apparatus as set forth in claim 11, wherein:
the selecting means selects the respective vacant regions for the simultaneously inputted data such that data to be recorded later is recorded onto a vacant region located in a downstream side with respect to a vacant region for data to be recorded earlier.

17. The recording apparatus as set forth in claim 11, further comprising:
vacant region allocating means for allocating the vacant regions detected by the detecting means, in accordance with a category of the data; and data category acquiring means for acquiring the category of the inputted data, wherein:
the selecting means selects the vacant region having the recording capacity larger than the data size of each of the data, the selecting being carried out, for each of the data, from the vacant regions allocated by the vacant region allocating means in accordance with the category, acquired by the data category acquiring means, of the data.

18. The method as set forth in claim 17, wherein:
the data category acquiring means is able to acquire EPG information, and acquires the category of the data in accordance with the EPG information.

19. The recording apparatus as set forth in claim 11, wherein:
in cases where the recording medium has a plurality of recording layers, the detecting means detects the continuous vacant regions in each of the layers of the recording medium.

20. The recording apparatus as set forth in claim 19, wherein:
the selecting means selects the vacant regions from vacant regions in a respective layer.

21. A data recording program for causing a computer to carry out the steps of the method as set forth in claim 1.

22. A recording medium for storing the data recording program as set forth in claim 21.
